(19) United States
(12) Patent Application Publication
(10) Pub. No.: US 2025/0362969 A1
(43) Pub. Date: Nov. 27, 2025

(54) DISTRIBUTED ARTIFICIAL INTELLIGENCE SYSTEM

(71) Applicant: Skymel Inc, Sunnyvale, CA (US)

(72) Inventors: Sushant Tripathy, Sunnyvale, CA (US); Neetu Pathak, Sunnyvale, CA (US)

(73) Assignee: Skymel Inc, Sunnyvale, CA (US)

(21) Appl. No.: 18/670,317

(22) Filed: May 21, 2024

(51) Int. Cl. G06F 9/50; G06F 9/48

(52) U.S. Cl. CPC G06F 9/505; G06F 9/485; G06F 9/5094; G06F 2209/485; G06F 2209/503

(57) ABSTRACT

A system to dynamically balance load between a server and a user device is disclosed. The system may include a system transceiver and a system processor. The system transceiver may be configured to obtain a request to execute a task from a user device. The system processor may obtain the request from the system transceiver and determine a machine learning (ML) model required to be implemented to execute the task. The system processor may determine a user device type, and determine a first ML sub-model, associated with the ML model, to be executed on the user device, and a second ML sub-model, associated with the ML model, to be executed on a server, based on the user device type. The system processor may cause the user device to execute the first ML sub-model and the server to execute the second ML sub-model to execute the task.

### FIELD

The present disclosure relates to Artificial Intelligence (AI), and more particularly to a distributed AI system.

### BACKGROUND

Typically in conventional AI inference-driven user-facing applications, which are served by AI systems, a central server is responsible for receiving requests from different user devices and for providing services to users based on the requests. The server includes a plurality of computing resources that may be used by different users to process their respective requests. Thus, all the processing is done on a single computer system, i.e., the server. Since all the computation is performed at a single computing system, such system has limited scalability. In addition, the system may be slow usually due to computational overload or network bandwidth overload caused by high volume of user requests, which may cause inconvenience to the users.

Therefore, there exists a need for a system and method that is more scalable, faster, more responsive, and provides better user experience.

### BRIEF DESCRIPTION OF THE DRAWINGS

The detailed description is set forth with reference to the accompanying drawings. The use of the same reference numerals may indicate similar or identical items. Various embodiments may utilize elements and/or components other than those illustrated in the drawings, and some elements and/or components may not be present in various embodiments. Elements and/or components in the figures are not necessarily drawn to scale. Throughout this disclosure, depending on the context, singular and plural terminology may be used interchangeably.

FIG. 1 depicts an environment in which techniques and structures for providing the systems and methods disclosed herein may be implemented.

FIG. 2 depict a block diagram of a split system and a user device in accordance with the present disclosure.

FIG. 3 depicts example inputs for a split system in accordance with the present disclosure.

FIG. 4 depicts a flow diagram of an example method to balance a computation load in accordance with the present disclosure.

### DETAILED DESCRIPTION

### Overview

The present disclosure describes a distributed Artificial Intelligence (AI) system that may dynamically balance computation load required to perform data processing/AI inferencing between different nodes of the system. The system may include a server and a user device (and other user devices) that may be configured to share the computation load to execute a task. The system may further include a split system that may be configured to divide task portion/computation load between the server and the user device. In some aspects, the split system may evaluate different parameters, and divide the task portion/computation load based on the parameters. The split system may be configured to determine whether the task may be performed entirely on the server, entirely on the user device, and partially on the server and partially on the user device based on the parameters, and accordingly cause the server and/or the user device to execute the task.

In some aspects, the split system may determine an AI or Machine Learning (ML) model that may be required to be implemented to execute the task. In addition, the split system may determine/select a first ML sub-model (associated with the ML model) to be executed by the user device, and a second ML sub-model (associated with the ML model) to be executed by the server. The split system may perform such determination/selections based on the parameters described above. Responsive to the determination/selection of the first ML sub-model and the second ML sub-model, the split system may cause the user device and the server to execute the first ML sub-model and the second ML sub-model respectively. The split system may then combine outcomes of the execution of the first ML sub-model and the second ML sub-model, and render the combined outcome on a user interface associated with the user device.

The parameters described above may include, but are not limited to, a user device type, available computing resources of the user device, a user device idle status, a user device battery status, a status of a network through which the user device may be communicatively coupled with the server or the system, cost, privacy, latency, and the combination thereof.

The present disclosure discloses a system and method that dynamically balances the computation load to execute the task between the server and the user device. The system enables the AI inference driven user facing application to be more scalable, faster, and responsive. In addition, the system provides same results even if the user is using different user devices, thereby providing a better user experience.

These and other advantages of the present disclosure are provided in detail herein.

### ILLUSTRATIVE EMBODIMENTS

The disclosure will be described more fully hereinafter with reference to the accompanying drawings, in which example embodiments of the disclosure are shown, and not intended to be limiting.

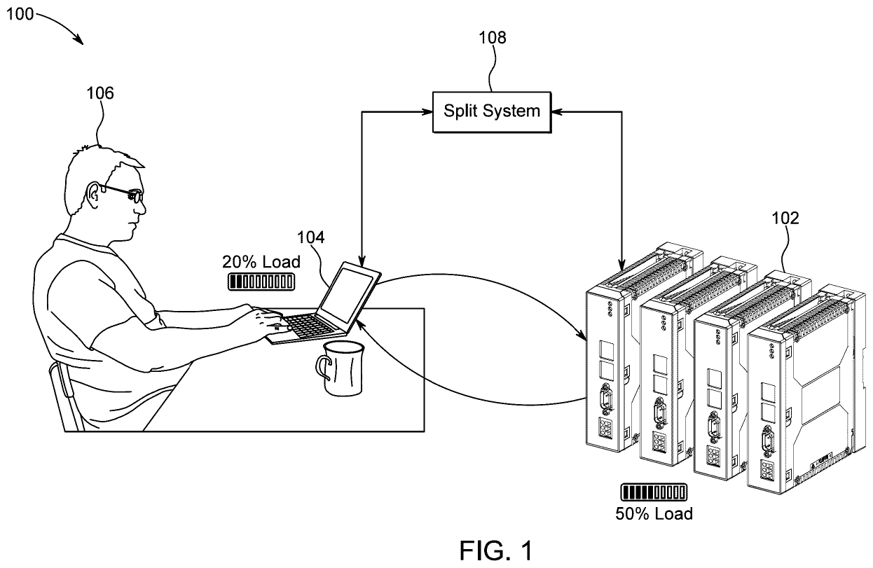

FIG. 1 depicts an environment 100 in which techniques and structures for providing the systems and methods disclosed herein may be implemented. The environment 100 may be a distributed Artificial Intelligence (AI) system in which the data processing/AI inferencing is shared across multiple nodes. Stated another way, in the distributed AI system, the data processing/AI inferencing may be distributed and performed by combined computing resources of multiple nodes.

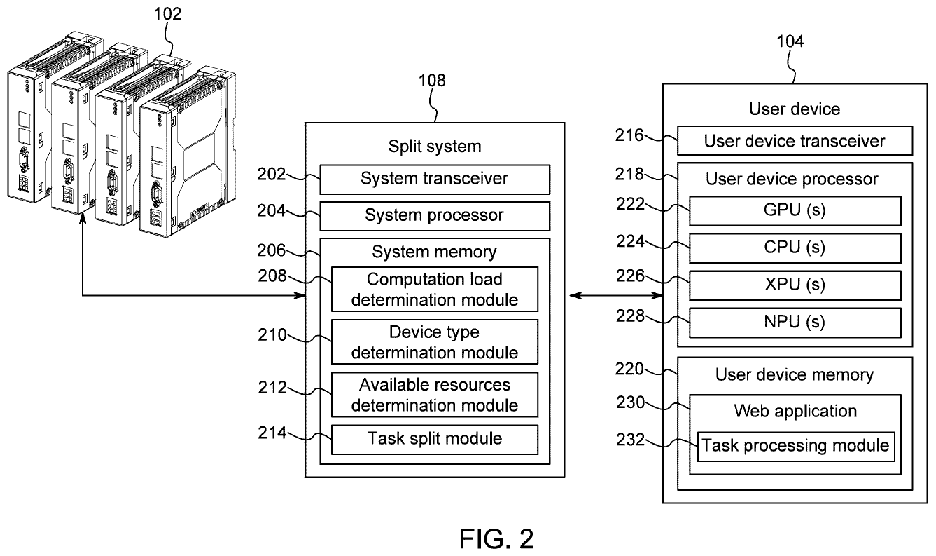

The distributed AI system (or the environment 100) may include a server 102 and a plurality of user devices (e.g., a user device 104 associated with a user 106) as nodes. The user device 104 may include, for example, a mobile phone, a laptop, a computer, a tablet, a wearable device (e.g., a smartwatch), or any other device with communication capabilities. Since the server 102 and the user device 104 are part of the distributed AI system, the server 102 and the user device 104 may be configured to share computing resources to perform data processing/AI inferencing. In some aspects, the user device 104 may include a plurality of computing resources including, but not limited to, graphics processing units (GPUs) (shown as GPUs 222 in FIG. 2), central processing units (CPUs) (shown as CPUs 224 in FIG. 2), neural processing units (or NPUs) (shown as NPUs 228 in FIG. 2), XPUs (shown as XPUs 226 in FIG. 2), and/or the like. Similarly, the server 102 may include a plurality of computing resources including, but not limited to, CPUs, GPUs, NPUs, XPUs, and/or the like. It should be noted that XPUs also cover extant and future data processing devices, both digital and analog, along with FPGAs and ASICs.

In some aspects, the server 102 and the user device 104 may be connected via a network (not shown). The network, as described here, illustrates an example communication infrastructure in which the connected devices discussed in various embodiments of this disclosure may communicate. The network may be and/or include the Internet, a private network, public network or other configuration that operates using any one or more known communication protocols such as transmission control protocol/Internet protocol (TCP/IP), Bluetooth®, Bluetooth® Low Energy (BLE), Wi-Fi based on the Institute of Electrical and Electronics Engineers (IEEE) standard 802.11, ultra-wideband (UWB), and cellular technologies such as Time Division Multiple Access (TDMA), Code Division Multiple Access (CDMA), High-Speed Packet Access (HSPDA), Long-Term Evolution (LTE), Global System for Mobile Communications (GSM), and Fifth Generation (5G), to name a few examples.

The environment 100 may further include a split system 108 that may be configured to dynamically balance the computation load required to perform the data processing/AI inferencing between the nodes (such as the server 102 and the user device 104). In some aspects, the split system 108 may dynamically balance the computation load required for AI inferencing on individual AI models (or Machine Learning (ML) model) between the server 102 and the user device 104. In an exemplary aspect, the split system 108 may be hosted on the server 102. In other aspects, the split system 108 may be installed or hosted partially on the server 102 and partially on the user device 104. In some additional configurations the split system may be hosted entirely on the user device 104.

The split system 108 may be configured to receive a user request, via the user device 104, to execute a task. In some aspects, the task may be responding to a user query that may be in natural language. In further aspects, the task may be, for example, rendering a video, playing a song/movie, classifying an image, segmenting an image, identifying individual objects present within an image, etc. Responsive to receiving the user request, the split system 108 may determine one or more ML models (e.g., neural models stored on the server 102 or previously cached on the user device 104) that may be required to implement or to execute the task. The split system 108 may further determine computational power/resources (or the computation load) that may be required to implement or execute the determined ML model(s).

Responsive to determining the required computational resources, the split system 108 may determine whether the ML model may be implemented on only the server 102, only the user device 104, or partially on the user device 104 and partially on the server 102. To perform such determination, the split system 108 may first determine a type of the user device 104. For example, the split system 108 may determine whether the user device 104 is a laptop, a mobile device, or a smartwatch, or an IoT device. In some aspects, the split system 108 may further determine, as part of the user device type, the computation power/resources of the user device 104 such as details of the CPUs, the GPUs, etc. of the user device 104. Responsive to determining the user device type, and the available computational capacity on the user device, the split system 108 may determine whether the ML model is to be implemented/executed on only the server 102, only the user device 104, or partially on the user device 104 and partially on the server 102, based on the user device type, available computational capacity and the computation load that may be required to implement the ML model.

When the split system 108 determines that the ML model is to be implemented using both the server 102 and the user device 104, the split system 108 may determine a first ML sub-model (also referred to as split model or stub model) that may be executed on the user device 104 and a corresponding second ML sub-model that may be executed on the server 102, to provide responses with inference integrity. Responsive to such determination, the split system 108 may cause the user device 104 and the server 102 to implement/execute the first ML sub-model and the second ML sub-model respectively. Specifically, the split system 108 may transmit a first command signal to the user device 104 to execute the first ML sub-model, and a second command signal to the server 102 to execute the second ML sub-model. In some aspects, the split system 108 may additionally fetch the first ML-sub-model from the server 102 and transmit to the user device 104, along with transmitting the first command signal.

As an example, when the split system 108 determines that the user device 104 may be a gaming laptop having very high computational power/resources, the split system 108 may determine that the ML model may be implemented/executed completely on the user device 104, to execute the task. On the other hand, when the user device 104 may be a mobile phone or a smartwatch, or IoT device with highly limited computational power/resources, the split system 108 may determine that the ML model may be executed completely on the server 102. Further, when the user device 104 may be a laptop with average computational power/resources, the split system 108 may determine that the ML model may be executed partially on the user device 104 and partially on the server 102. In this case, the split system 108 may cause the laptop/user device 104 to implement the first ML sub-model, and the server 102 to implement the second ML sub-model, as described above.

In addition or alternative to using the user device type for determining whether to “split” the ML model or not, the split system 108 may evaluate/use additional parameters to determine whether the ML model is to be implemented/executed on only the server 102, only the user device 104, or partially on the user device 104 and partially on the server 102. The additional parameters may include, but are not limited to, available computing resources of the user device 104, a user device battery status, a network status associated with the user device 104, an idle status of the user device 104, response latency, cost, and accuracy, data-privacy, and/or the like associated with the user device 104 and/or the process involving transmission of the first ML sub-model to the user device 104. The details of the additional parameters may be understood in conjunction with FIG. 2 described below.

In some aspects, the split system 108 may determine and execute the same ML model for the task, irrespective of the user device type. Stated another way, the ML model that is required to be implemented to execute the given task is not dependent on the user device type or available compute capacity. In this manner, the split system 108 ensures that it provides the same result for the task, even if the user is using different user devices, or has reduced compute capacity available on user devices (because other running applications are consuming them) thereby providing a better, and uniform user experience.

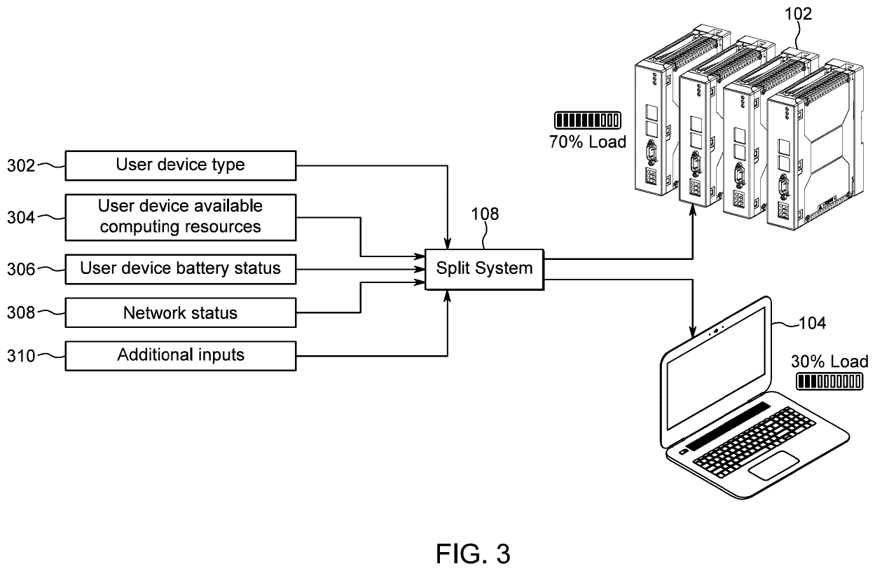

FIG. 2 depicts a block diagram of the split system 108 and the user device 104 in accordance with the present disclosure. While explaining FIG. 2, references will be made to FIG. 3. The split system 108 may include a plurality of components including, but not limited to, a system transceiver 202, a system processor 204, a system memory 206, and/or the like. The system memory 206 may include a plurality of components including, but not limited to, a computation load determination module 208, a device type determination module 210, an available resources determination module 212, a task split module 214, and/or the like. The modules described here may be stored in the form of computer-executable instructions, and the system processor 204 may be configured and/or programmed to execute the stored computer-executable instructions for performing functions/operations in accordance with the present disclosure. The details of these modules are described later in the present disclosure.

The system transceiver 202 may be configured to transmit/receive information or data to/from the user device 104 and the server 102. For example, the system transceiver 202 may be configured to obtain the request to execute the task from the user device 104. The details of the task are described in FIG. 1. In addition, the system transceiver 202 may be configured to fetch the ML model(s) (or a portion of the ML model) from the server 102, and transmit the ML model(s) to the user device 104.

The system processor 204 may utilize the system memory 206 to store programs in code and/or to store data for performing aspects in accordance with the disclosure. The system memory 206 may be a non-transitory computer-readable storage medium or memory storing a program code that enables the system processor 204 to perform operations in accordance with the present disclosure. The system memory 206 may include any one or a combination of volatile memory elements (e.g., dynamic random-access memory (DRAM)), Graphics Processing Unit random access memory (GPU-VRAM), synchronous dynamic random-access memory (SDRAM), etc.) and may include any one or more nonvolatile memory elements (e.g., erasable programmable read-only memory (EPROM), flash memory, electronically erasable programmable read-only memory (EEPROM), programmable read-only memory (PROM), etc.).

The user device 104 may include a plurality of components including, but not limited to, a user device transceiver 216, a user device processor 218, a user device memory 220, and/or the like. The user device processor 218 may in turn include a plurality of components including, but not limited to, GPUs 222, CPUs 224, XPUs 226, and NPUs 228. The user device memory 220 may include a web application 230 that may be associated with the server 102. The user 106 may access the data stored in the server 102 by using the web application 230 stored in the user device 104. In some aspects, the web application 230 may include a task processing module 232, which can include tasks such as computing the ML model inference outputs, and storing ML models (sub-models and full-models) downloaded from the server 102.

The user device transceiver 216 may be configured to transmit/receive information or data to/from the server 102 and the split system 108. For example, the user device transceiver 216 may be configured to receive the ML model(s) from the server 102 via the system transceiver 202 (or directly from the server 102). In addition, the user device transceiver 216 may be configured to transmit the request to the system transceiver 202 to execute the task.

The user device processor 218 may utilize the user device memory 220 to store programs in code and/or to store data for performing aspects in accordance with the disclosure. The user device memory 220 may be a non-transitory computer-readable storage medium or memory storing a program code that enables the user device processor 218 to perform operations in accordance with the present disclosure. The user device memory 220 may include any one or a combination of volatile memory elements (e.g., dynamic random-access memory (DRAM), Graphics Processing Unit random access memory (GPU-VRAM), synchronous dynamic random-access memory (SDRAM), etc.) and may include any one or more nonvolatile memory elements (e.g., erasable programmable read-only memory (EPROM), flash memory, electronically erasable programmable read-only memory (EEPROM), programmable read-only memory (PROM), etc.).

In operation, the system transceiver 202 may receive/obtain the request to execute the task from the user device 104 (via the user device transceiver 216). In some aspects, the system transceiver 202 may receive the request when the user 106 accesses the web application 230 stored in the user device memory 220. Responsive to obtaining the request, the system transceiver 202 may transmit the request to the system processor 204 (and may additionally save the request in the system memory 206). The system processor 204 may obtain the request from the system transceiver 202, and determine a machine learning (ML) model (stored on the server 102, or cached on user device 104) required to be implemented to execute the task responsive to obtaining the request. For example, when the task is associated with rendering a video on the user device 104, the system processor 204 may identify ML model(s) that may render the requested video on the user device 104.

Responsive to determining/identifying the ML model, the system processor 204 may calculate, via the computation load determination module 208, the required computation load for executing the ML model or a computation load to execute the task. For example, the system processor 204 may perform image analysis/processing of the video to be rendered on the user device 104 to determine the required computation load. The required computation may be high when the images associated with the video are of high-resolution, and may be low when the images are of low-resolution.

In addition to determining the required computation load, the system processor 204 may determine, via the device type determination module 210, a user device type 302 (as shown in FIG. 3) of the user device 104 to determine whether the user device 104 may have capability to run/execute the ML model (or a portion of the ML model). In an exemplary aspect, to determine the user device type, the system processor 204 may determine static configuration of the user device 104 (e.g., information associated with the computation power/resources of the user device 104 like the CPUs 224, the GPUs 222, etc.). The system processor 204 may fetch such details from the user device 104 or may transmit a request to the user device 104 to obtain such information. In further aspects, the system processor 204 may identify a user device model to determine the static configuration or the user device type.

Responsive to determining the user device type as described above, the system processor 204 may correlate the determined user device type (or user device static configuration) with the computation load that may be required to implement the identified appropriate ML model to determine whether the user device 104 may have the capability to implement/execute the ML model. Based on the correlation, the system processor 204 may determine whether the ML model may be implemented/executed only on the server 102, only on the user device 104, or partially on the user device 104 and partially on the server 102. If the system processor 204 determines that the user device 104 may not be able to implement the ML model (or a portion of the ML model), the system processor 204 may implement the ML model entirely on the server 102 (e.g., when the computational power of the user device 104 may be substantially less as compared to the required computation load to execute the task e.g., when the user device 104 may be an old model mobile device). On the other hand, the system processor 204 may implement the ML model entirely on the user device 104 when the computational power of the user device 104 may be very high as compared to the required computation load to execute the task. In some aspects, the system processor 204 may fetch a mapping of the user device type and respective computational powers of user devices from the system memory 206, and determine the computational power of the user device 104 based on mapping.

In further aspects, the system processor 204 may divide the task/load between the server 102 and the user device 104 to execute the task, when the system processor 204 determines that the ML model may be implemented/executed partially on the user device 104 and partially on the server 102 based on the user device type. Specifically, the system processor 204 may determine (or select), via the task split module 214, a first ML sub-model, associated with the ML model, to be executed on the user device 104, and a corresponding second ML sub-model, associated with the full ML model, to be executed on the server 102, based on the user device type and the computation load that may be required to implement the ML model. The first ML sub-model may be associated with a first task portion (and may consume/require a first computation load), and the second ML sub-model may be associated with a second task portion (and may consume/require a second computation load).

In some aspects, the system processor 204 may select the first ML sub-model and the second ML sub-model such that the computation load may be equally divided between the server 102 and the user device 104. In other aspects, the system processor 204 may select the first ML sub-model and the second ML sub-model such that the computation load may be divided unequally between the server 102 and the user device 104. For example, the computation load associated with server 102 may be 70% of a total computation load required to execute the ML model, and the computation load associated with the user device 104 may be 30% of the total computation load, as shown in FIG. 3.

Responsive to determining/selecting the first ML sub-model and the second ML sub-model, the system processor 204 may cause the user device 104 to execute the first ML sub-model and the server 102 to execute the second ML sub-model to execute the task. To cause the server 102 to execute the second ML sub-model (e.g., to process the second task portion), the system processor 204 may transmit a first command signal to the server 102 to execute the second ML sub-model. The server 102 may receive the first command signal, execute the second ML sub-model and generate a first outcome. The server 102 may transmit the first outcome to the system processor 204.

In addition, to cause the user device 104 to execute the first ML sub-model (e.g., to process the first task portion), the system processor 204 may fetch the first ML sub-model from the server 102 and transmit the first ML sub-model to the user device 104, via the network. The system processor 204 may further transmit a second command signal to the user device 104 to cause the user device 104 to execute the first ML sub-model. The user device 104 (or the user device transceiver 216) may receive/obtain the first ML sub-model and the second command signal, and transmit the first ML sub-model to the user device processor 218. The user device processor 218 may use the task processing module 232 to execute the first ML sub-model, and generate a second outcome. The user device processor 218 may then transmit the second outcome to the system processor 204, via the user device transceiver 216 and the system transceiver 202.

The system processor 204 may obtain the first outcome and the second outcome from the server 102 and the user device 104 respectively and combine the first outcome and the second outcome to generate a combined output. Responsive to combining the first outcome and the second outcome, the system processor 204 may transmit the combined output to the user device 104 for rendering on a user interface. In some aspects, instead of the system processor 204 combining the first outcome and the second outcome, the server 102 may directly obtain the second outcome from the user device 104, combine the first outcome and the second outcome, and transmit the combined output to the user device 104. In other aspects, the user device 104 may obtain the first outcome from the server 102, and combine the first outcome with the second outcome, and render the combined output on the user interface.

In some aspects, the system processor 204 may cause the user device 104 and the server 102 to execute the respective first ML sub-model and the second ML sub-model simultaneously. Stated another way, the system processor 204 may cause the user device 104 and the server 102 to process the first task portion and the second task portion simultaneously. Alternatively, the system processor 204 may cause the user device 104 and the server 102 to execute the respective first ML sub-model and the second ML sub-model sequentially. Stated another way, the system processor 204 may cause the user device 104 and the server 102 to process the first task portion and the second task portion sequentially. For example, the system processor 204 may first cause the user device 104 to process the first task portion and generate the second outcome, and transmit the second outcome to the server 102 (via the system transceiver 202 or directly). The server 102 may then generate the first outcome responsive to obtaining the second outcome. In such cases, the first outcome may be based on the second outcome, the first outcome may be transmitted to the user device 104 (e.g. via the split system 18 or directly from the server 102).

In some aspects, in addition or alternative to determining the user device type as described above, the system processor 204 may determine, via the available resources determination module 212, available computing resources 304 associated with the user device 104, from a plurality of computing resources including the GPUs 222, the CPUs 224, the XPUs 226, the NPUs 228, etc. To determine the available computing resources 304, the system processor 204 may determine a dynamic configuration of the user device 104 (e.g., information associated with the occupied computation power/resources and unoccupied computation power/resources of the user device 104 or real-time occupancy of the computation resources). Stated another way, to determine the available computing resources 304, the system processor 204 may determine available GPU/CPU capacity. The system processor 204 may fetch such details from the user device 104 or may transmit a request to the user device 104 to obtain such information.

The system processor 204 may determine whether the ML model is to be implemented/executed on only the server 102, only the user device 104, or partially on the user device 104 and partially on the server 102 based on the available computing resources 304. For example, when the available GPU/CPU capacity is greater than a first threshold, the system processor 204 may determine that the ML model may be implemented on the user device 104. On the other hand, when the available GPU/CPU capacity is less than a second threshold, the system processor 204 may determine that the ML model may be implemented on the server 102. In addition, the system processor 204 may determine the first ML sub-model to be executed on the user device 104, and the second ML sub-model to be executed on the server 102, based on the available computing resources 304 (e.g., when the available GPU/CPU capacity between the first threshold and the second threshold).

In some aspects, the system processor 204 may determine the available computation resources 304 when the system processor 204 determines that the user device 104 may be capable of implementing the ML model (or a portion of the ML model) based on the user device type. In further aspects, the system processor 204 may determine whether the user device 104 is idle or not, and may cause the user device 104 to execute the first ML sub-model responsive to a determination that the user device 104 is idle.

In further aspects, the system processor 204 may determine a battery status 306 of the user device 104. The system processor 204 may fetch the battery details from the user device 104 or may transmit a request to the user device 104 to obtain such information. The system processor 204 may determine whether the ML model may be implemented/executed only on the server 102, only on the user device 104, or partially on the user device 104 and partially on the server 102 based on the battery status 306. For example, when the battery status 306 indicates that the battery power is greater than a third threshold, the system processor 204 may determine that the ML model may be implemented on the user device 104. On the other hand, when the battery power is less than a fourth threshold, the system processor 204 may determine that the ML model may be implemented on the server 102. In addition, the system processor 204 may determine/select the first ML sub-model to be executed on the user device 104, and the second ML sub-model to be executed on the server 102, based on the battery status 306 (e.g., when the battery power is between the third threshold and the fourth threshold).

In further aspects, the system processor 204 may determine a network status 308 associated with the user device 104. Stated another way, the system processor 204 may determine the status of the network through which the user device 104 may be connected to the server 102/split system 108. The system processor 204 may determine whether the ML model may be implemented/executed only on the server 102, only on the user device 104, or partially on the user device 104 and partially on the server 102 based on the network status 308. For example, when the network status 308 indicates that the network strength is greater than a fifth threshold, the system processor 204 may determine that the ML model may be implemented on the user device 104. On the other hand, when the network strength is less than a sixth threshold, the system processor 204 may determine that the ML model may be implemented on the server 102 (as the server 102 may not be able to efficiently transmit the ML model or portion of the ML model via a weak network to the user device 104). In addition, the system processor 204 may determine/select the first ML sub-model to be executed on the user device 104, and the second ML sub-model to be executed on the server 102, based on the network status 308 (e.g., when the network power is between the fifth threshold and the sixth threshold).

In further aspects, the system processor 204 may obtain additional inputs 310 to execute the task, and determine whether the ML model may be implemented/executed only on the server 102, only on the user device 104, or partially on the user device 104 and partially on the server 102 based on the additional inputs 310. The additional inputs 310 may include, but are not limited to latency, cost, accuracy/quality, or privacy. In addition, the system processor 204 may determine/select the first ML sub-model to be executed on the user device 104, and the second ML sub-model to be executed on the server 102, based on the additional inputs 310. In some aspects, the additional inputs 310 may be set by a server operator.

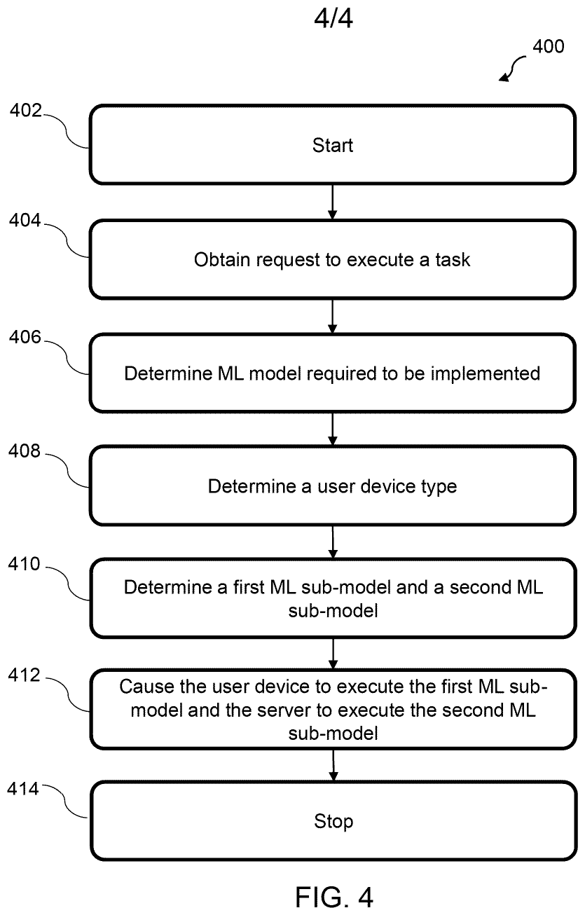

FIG. 4 depicts a flow diagram of an example method 400 to balance a computation load in accordance with the present disclosure. FIG. 4 may be described with continued reference to prior figures. The following process is exemplary and not confined to the steps described hereafter. Moreover, alternative embodiments may include more or less steps than are shown or described herein and may include these steps in a different order than the order described in the following example embodiments.

The method 400 starts at step 402. At step 404, the method 400 may include obtaining, by the system processor 204, the request to execute the task from the user device 104. At step 406, the method 400 may include determining, by the system processor 204, the ML model required to be implemented to execute the task responsive to obtaining the request. At step 408, the method 400 may include determining, by the system processor 204, the user device type. At step 410, the method 400 may include determining, by the system processor 204, the first ML sub-model, associated with the ML model, to be executed on the user device 104, and the second ML sub-model, associated with the ML model, to be executed on the server 102, based on the user device type. At step 412, the method 400 may include causing, by the system processor 204, the user device 104 to execute the first ML sub-model, and the server 102 to execute the second ML sub-model to execute the task.

At step 414, the method 400 may stop.

In the above disclosure, reference has been made to the accompanying drawings, which form a part hereof, which illustrate specific implementations in which the present disclosure may be practiced. It is understood that other implementations may be utilized, and structural changes may be made without departing from the scope of the present disclosure. References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a feature, structure, or characteristic is described in connection with an embodiment, one skilled in the art will recognize such feature, structure, or characteristic in connection with other embodiments whether or not explicitly described.

Further, where appropriate, the functions described herein can be performed in one or more of hardware, software, firmware, digital components, or analog components. For example, one or more application specific integrated circuits (ASICs) can be programmed to carry out one or more of the systems and procedures described herein. Certain terms are used throughout the description and claims refer to particular system components. As one skilled in the art will appreciate, components may be referred to by different names. This document does not intend to distinguish between components that differ in name, but not function.

It should also be understood that the word “example” as used herein is intended to be non-exclusionary and non-limiting in nature. More particularly, the word “example” as used herein indicates one among several examples, and it should be understood that no undue emphasis or preference is being directed to the particular example being described.

A computer-readable medium (also referred to as a processor-readable medium) includes any non-transitory (e.g., tangible) medium that participates in providing data (e.g., instructions) that may be read by a computer (e.g., by a processor of a computer). Such a medium may take many forms, including, but not limited to, non-volatile media and volatile media. Computing devices may include computer-executable instructions, where the instructions may be executable by one or more computing devices such as those listed above and stored on a computer-readable medium.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating various embodiments and should in no way be construed so as to limit the claims.

Accordingly, it is to be understood that the above description is intended to be illustrative and not restrictive. Many embodiments and applications other than the examples provided would be apparent upon reading the above description. The scope should be determined, not with reference to the above description, but should instead be determined with reference to the appended claims, along with the full scope of equivalents to which such claims are entitled. It is anticipated and intended that future developments will occur in the technologies discussed herein, and that the disclosed systems and methods will be incorporated into such future embodiments. In sum, it should be understood that the application is capable of modification and variation.

All terms used in the claims are intended to be given their ordinary meanings as understood by those knowledgeable in the technologies described herein unless an explicit indication to the contrary is made herein. In particular, use of the singular articles such as “a,” “the,” “said,” etc. should be read to recite one or more of the indicated elements unless a claim recites an explicit limitation to the contrary. Conditional language, such as, among others, “can,” “could,” “might,” or “may,” unless specifically stated otherwise, or otherwise understood within the context as used, is generally intended to convey that certain embodiments could include, while other embodiments may not include, certain features, elements, and/or steps. Thus, such conditional language is not generally intended to imply that features, elements, and/or steps are in any way required for one or more embodiments.

That which is claimed is:

1. A system comprising:
a system transceiver configured to obtain a request to execute a task from a user device; and
a system processor communicatively coupled to the system transceiver, wherein the system processor is configured to:
obtain the request from the system transceiver;
determine a machine learning (ML) model required to be implemented to execute the task responsive to obtaining the request;
determine a user device type;
determine a first ML sub-model, associated with the ML model, to be executed on the user device, and a second ML sub-model, associated with the ML model, to be executed on a server, based on the user device type; and
cause the user device to execute the first ML sub-model and the server to execute the second ML sub-model to execute the task.

2. The system of claim 1, wherein the system processor is further configured to:
calculate a required computation load to execute the ML model; and
determine the first ML sub-model and the second ML sub-model based on the required computation load.

3. The system of claim 1, wherein the system processor is further configured to:
determine available computing resources of the user device, from a plurality of computing resources, to execute the ML model; and
determine the first ML sub-model and the second ML sub-model based on the available computing resources.

4. The system of claim 1, wherein the system processor is further configured to:
obtain additional inputs to execute the task, wherein the additional inputs comprise one or more of a latency, a cost, an accuracy, or privacy; and
determine the first ML sub-model and the second ML sub-model based on the additional inputs.

5. The system of claim 1, wherein the system processor is further configured to:
determine a battery status of the user device; and
determine the first ML sub-model and the second ML sub-model based on the battery status.

6. The system of claim 1, wherein the system processor is further configured to:
determine a network status associated with the user device; and
determine the first ML sub-model and the second ML sub-model based on the network status.

7. The system of claim 1, wherein the system processor is further configured to:
determine that the user device is idle; and
cause the user device to execute the first ML sub-model responsive to determining that the user device is idle.

8. The system of claim 1, wherein the system processor is further configured to:
fetch the first ML sub-model from the server responsive to determining the first ML sub-model;
transmit the first ML sub-model from the server to the user device; and
cause the user device to execute the first ML sub-model, responsive to transmitting the first ML sub-model.

9. The system of claim 1, wherein the system processor is further configured to transmit a first command signal to the user device to execute the first ML sub-model on the user device.

10. The system of claim 1, wherein the system processor is further configured to transmit a second command signal to the server to execute the second ML sub-model on the server.

11. The system of claim 1, wherein the system processor is further configured to cause the user device to execute the first ML sub-model and the server to execute the second ML sub-model sequentially.

12. The system of claim 1, wherein the system processor is further configured to cause the user device to execute the first ML sub-model and the server to execute the second ML sub-model simultaneously.

13. A method comprising:
obtaining, by a processor, a request to execute a task from a user device;
determining, by the processor, a machine learning (ML) model required to be implemented to execute the task responsive to obtaining the request;
determining, by the processor, a user device type;
determining, by the processor, a first ML sub-model, associated with the ML model, to be executed on the user device, and a second ML sub-model, associated with the ML model, to be executed on a server, based on the user device type; and
causing, by the processor, the user device to execute the first ML sub-model and the server to execute the second ML sub-model to execute the task.

14. The method of claim 13 further comprising:
calculating a required computation load to execute the ML model; and
determining the first ML sub-model and the second ML sub-model based on the required computation load.

15. The method of claim 13 further comprising:
determining available computing resources of the user device, from a plurality of computing resources, to execute the ML model; and
determining the first ML sub-model and the second ML sub-model based on the available computing resources.

16. The method of claim 13 further comprising:
obtaining additional inputs to execute the task, wherein the additional inputs comprise one or more of a latency, a cost, an accuracy, or privacy; and
determining the first ML sub-model and the second ML sub-model based on the additional inputs.

17. The method of claim 13 further comprising:
determining a battery status of the user device; and
determining the first ML sub-model and the second ML sub-model based on the battery status.

18. The method of claim 13 further comprising:
determining a network status associated with the user device; and
determining the first ML sub-model and the second ML sub-model based on the network status.

19. The method of claim 13 further comprising:
determining that the user device is idle; and
causing the user device to execute the first ML sub-model responsive to determining that the user device is idle.

20. A non-transitory computer-readable storage medium having instructions stored thereupon which, when executed by a processor, cause the processor to:
obtain a request to execute a task from a user device;
determine a machine learning (ML) model required to be implemented to execute the task responsive to obtaining the request;
determine a user device type;
determine a first ML sub-model, associated with the ML model, to be executed on the user device, and a second ML sub-model, associated with the ML model, to be executed on a server, based on the user device type; and
cause the user device to execute the first ML sub-model and the server to execute the second ML sub-model to execute the task.
